(19) United States
(12) Patent Application Publication
(10) Pub. No.: US 2008/0279493 A1
(43) Pub. Date: Nov. 13, 2008

(54) HYDRODYNAMIC BEARING DEVICE, AND SPINDLE MOTOR AND INFORMATION DEVICE EQUIPPED WITH SAME

(76) Inventors: Shouji MASAZUKI, Ehime (JP); Toshifumi Hino, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/111,058

(22) Filed: Apr. 28, 2008

(30) Foreign Application Priority Data
Apr. 26, 2007 (JP) 2007-117663

(51) Int. Cl. F16C 32/06; H02K 7/08

(52) U.S. Cl. 384/100; 310/90

(57) ABSTRACT

A bearing component 7 comprises a sleeve 2 having a bearing hole 2a in which a shaft 1 is inserted, a communicating hole 6 formed in the sleeve 2, a lubricant 20 held in the gap between the shaft 1 and the sleeve 2, for example, an inner peripheral seal portion 12 that holds the lubricant 20 in the bearing component 7, and a flow suppressing wall 30 formed between the communicating hole 6 and the inner peripheral seal portion 12. The flow suppressing wall 30 impedes the flow of the lubricant 20 toward the inner peripheral seal portion 12, and disperses it in the circumferential direction.

### TECHNICAL FIELD

The present invention relates to a hydrodynamic bearing device that is mounted in a device for recording or reproducing information, such as a hard disk drive (hereinafter referred to as HDD), and to a spindle motor and an information device equipped with this hydrodynamic bearing device.

### BACKGROUND ART

In recent years HDDs have been developed for personal computers as well as various mobile applications, and there is an increasing need for them to be made smaller and thinner. Along with this, the hydrodynamic bearing device and spindle motor that are the main constituents of an HDD also need to be smaller and thinner, and a longer service life is also necessary.

To meet this need for reduced thickness and longer service life, conventional hydrodynamic bearing devices have been proposed with configurations in which thickness is reduced in the bearing seal portion used to prevent the lubricant from leaking out from the bearing, and the supply of lubricant can be increased.

For example, Patent Document 1 (Japanese Laid-Open Patent Application No, 2006-162029) discloses a hydrodynamic bearing device in which a first bearing seal portion is provided between a shaft and a cover member provided over a sleeve, and a second bearing seal portion is provided between the cover member and the outer peripheral face of the sleeve. With this configuration, a vent hole is provided to the second bearing seal portion, and changes in the amount of remaining lubricant are absorbed by the second bearing seal portion, so the service life is longer than in the past, and the resulting bearing seal member is thinner.

Also, Patent Document 2 (Japanese Laid-Open Patent Application No, 2006-161988) discloses a hydrodynamic bearing device in which a first bearing seal portion is provided between a shaft and a cover member provided over a sleeve, and a second bearing seal portion is constituted by providing a tapered face, in which the axial gap varies in the circumferential direction, in the axial space between the cover member and the sleeve. With this configuration, a vent hole is provided to the second bearing seal portion in the region of the second bearing seal portion where the axial gap is greatest, and changes in the amount of remaining lubricant are absorbed by the second bearing seal portion, so the service life is longer than in the past, and the resulting bearing seal member is thinner.

In order to eliminate a state of unequal pressure in the lubricant inside the bearing, the hydrodynamic bearing devices disclosed in both of the above publications had a communicating path that communicated between a closed end side (inside the bearing) and an open end side, and this eliminated the dynamic pressure variance generated in the hydrodynamic grooves.

### DISCLOSURE OF INVENTION

With the conventional configurations discussed above, however, there is the risk that the following problems will be encountered if the HDD in which the hydrodynamic bearing device is mounted should be accidentally dropped, or if the HDD should be bumped when being installed inside a computer, or if a spindle motor should be subjected to a powerful external impact.

Specifically, the shaft member that supports a rotating body whose mass has increased due to the loading of a disk or the like moves violently up and down inside the bearing hole. At this point, the relative position of the shaft member with respect to the sleeve member fluctuates violently for a short time, and there is the risk that the lubricant may suddenly move through the communicating path, or that the lubricant may leak out from the bearing seal portion near the communicating path.

This phenomenon, whereby the lubricant leaks out in the event that the hydrodynamic bearing device is subjected to an external impact, etc., will be described below through reference to the drawings.

FIG. 14A is a lateral cross section of a conventional hydrodynamic bearing device mounted in a spindle motor. Here, the normal orientation in which the disk is mounted above the motor is shown as being reversed. A thrust flange 403 is affixed to a shaft 401, and the shaft 401 is relatively rotatably inserted in a bearing hole 402a of a sleeve 402 via a microscopic gap. The sleeve 402 is closed off at one end by a thrust plate 404, and is open at the other end.

An ester oil or other such lubricant 420 is held in the microscopic gap formed between the shaft member and the sleeve member. The lubricant 420 held in this bearing may be considered to be a substantially non-compressible fluid. A radial hydrodynamic groove (not shown) is formed between the sleeve 402 and the shaft 401. A thrust hydrodynamic groove (not shown) is formed between the sleeve 402 or the thrust plate 404 and the thrust flange 403. As a result, when the shaft 401 (the rotating side) rotates relatively with respect to the sleeve 402 (the stationary side), the shaft member, which includes the shaft 401 and the thrust flange 403, maintains the sleeve member, consisting of the sleeve 402 and the thrust plate 404, in a state of non-contact rotation.

Further, a communicating hole 406 for eliminating a state of unequal dynamic pressure inside the rotating bearing is formed between the open end side and the close end side of the sleeve member.

In a normal state, a rotor magnet (not shown) and a stator core (not shown) or base (not shown) are provided so that the shaft member will be biased in one direction by magnetic attraction with respect to the sleeve member. Therefore, in a state of free fall, the thrust flange 403 is biased to the thrust plate 404, and axial play ΔZ is formed between the thrust flange 403 and the sleeve 402.

Here, a cover 405 is provided on the open end side of the sleeve 402. A first bearing seal portion is formed between the outer peripheral face of the shaft 401 and an inner peripheral opening 405a in the cover 405. A tapered face over which the axial gap varies is formed in the circumferential direction between the cover 405 and the sleeve 402. A vent hole 413 is formed in the largest gap portion. This tapered face constitutes a second bearing seal portion.

If the device should fall in the downward direction of the drawing and hit the ground, as shown in FIG. 14B, first the sleeve member will be subjected to a braking force, while inertia will be at work on the shaft member. Therefore, the thrust flange 403 lifts up by the above-mentioned play amount ΔZ from the thrust plate 404, and the thrust flange 403 hits the sleeve 402. At this point the lubricant held in the bearing attempts to maintain a state of constant volume, so when the shaft member lifts up by ΔZ, there is a lack of the lubricant 420 by a volume of ΔV, which corresponds to ΔV=π/4×Ds²×ΔZ. Ds here is the outside diameter of the shaft 401. In a normal usage state, the lack of lubricant 420 is automatically adjusted for by an even change in the liquid level at the second bearing seal portion.

However, when the relative position of the shaft member with respect to the sleeve member suddenly changes, such as when the device is dropped, the lubricant 420 cannot move in the required volume between the thrust flange 403 and the thrust plate 404 because of its viscous resistance. In this case, a state of negative pressure is created between the thrust flange 403 and the thrust plate 404. In a normal state, air is dissolved in the lubricant 420, but when the air pressure drops, the air cannot dissolve any longer. As a result, a bubble 480 is instantaneously generated between the thrust flange 403 and the thrust plate 404. The volume of this bubble 480 is either substantially ΔV, or slightly less than ΔV. In this case, there is only a slight change in the liquid levels at the first and second bearing seal portions.

When time on the sub-millisecond order has passed since the state in FIG. 14B, the thrust flange 403 that has struck the sleeve 402 rebounds and then hits the thrust plate 404 as shown in FIG. 14C. As a result, the shaft member is suddenly pushed back into the sleeve member. However, the bubble 480 generated between the thrust flange 403 and the thrust plate 404 cannot instantaneously dissolve back into the lubricant 420, and as a result, a volume of lubricant equal to that of the bubble 480 is pushed outside the bearing through the communicating hole 406, which has the lowest viscous resistance. At this point, the change from FIG. 14B to FIG. 14C happens in a short time, so a change in the liquid level corresponding to ΔV occurs in the first bearing seal portion. At this point, if the bubble has already been admixed into the lubricant 420 in the state shown in FIG. 14B, then in the state shown in FIG. 14C the liquid level is higher than in the state shown in FIG. 14A prior to the fall. Therefore, there is the risk that the lubricant near the region closest to the communicating hole 406 will leak out of the bearing seal portion near the first bearing seal portion.

This phenomenon is usually not a problem if the disk mass is low and the drop impact value is around 1000 G, but with an HDD used in a server application, for example, the thickness and number of disks are greater, and the mass of the rotating body is also larger, in which case this phenomenon tends to occur even at less than 1000 G.

Thus, when a conventional hydrodynamic bearing device was subjected to a large and sudden impact, such as when it was dropped, there was the risk that the lubricant flowing in and out of the communicating path would leak out from the bearing seal portion.

It is an object of the present invention to provide a hydrodynamic bearing device whose sealing performance is good enough to prevent the lubricant from leaking outside even when subjected to an external impact, and to provide a spindle motor and an information device equipped with this hydrodynamic bearing device.

The hydrodynamic bearing device pertaining to the first invention comprises a shaft member, a sleeve member, a communicating path, a lubricant, a bearing seal portion, and a flow suppressor. The sleeve member has a bearing hole which includes an open end and a closed end in the axial direction, with the shaft member being rotatably inserted in the bearing hole via a microscopic gap. The communicating path is made in the sleeve member and communicates between a space inside the bearing on the closed end side and a space inside the bearing on the open end side. The lubricant is held at least in the microscopic gap and the communicating path. The bearing seal portion is disposed on the open-side end face side of the sleeve member and more to the inner peripheral side or the outer peripheral side than the communicating path, and suppresses leakage of the lubricant to outside the bearing by capillary action working between the bearing seal portion and the shaft member. The flow suppressor is formed between the bearing seal portion and the communicating path and suppresses the flow of lubricant that has moved in from the communicating path toward the bearing seal portion.

The hydrodynamic bearing device here is configured such that a shaft member, which is inserted in a bearing hole formed in a sleeve having a communicating hole, is rotatably supported via a lubricant, wherein a flow suppressor that hinders the flow of lubricant coming in from a communicating path formed in the sleeve is provided to a region between the bearing seal portion and the communicating path.

The above-mentioned flow suppressor includes, for example, a convex member formed on the end face on the bearing seal side of the sleeve, or on a face opposite the sleeve on a cover member attached on this end face side. Also, the flow suppressor may be formed extending in the axial direction up to a position that completely blocks off a line linking the communicating path and the bearing seal portion, or may be formed in a state of maintaining a slight gap in the axial direction. Furthermore, the above-mentioned shaft member encompasses, for example, a shaft by itself, a configuration in which a shaft is combined with a flange, and a configuration in which a shaft is combined with a rotor hub. Also, the sleeve member encompasses, for example, not only a bearing sleeve (inner sleeve), but also a sleeve holder (outer sleeve) or a thrust plate or the like attached to the closed end side.

In general, when a hydrodynamic bearing device is subjected to impact, vibration, or the like, the shaft moves up and down in the axial direction relative to the sleeve. At this point the relative position of the shaft with respect to the sleeve fluctuates violently, the result being that the inside of the bearing enters a negative pressure state at a place where a gap widens momentarily (such as between the thrust flange and the thrust plate), which generates a bubble. When the gap closes back up at the place where this bubble has formed, a volume of lubricant corresponding to that of the bubble is pushed out. Consequently, the lubricant that is pushed out may go through the communicating path, which has the lowest flow resistance, and flow all at once into the bearing seal portion formed at the open end side. When this happens, since the distance between the communicating path and the bearing seal portion is relatively short, there is the risk that the momentum of the lubricant coming out of the communicating path will cause it to leak from the bearing seal portion to the outside.

With the hydrodynamic bearing device of the present invention, a flow suppressor is provided to a region between the communicating path and the bearing seal portion in order to reduce the leakage of lubricant through the communicating path to the outside from the bearing seal portion when the hydrodynamic bearing device is subjected to impact or vibration as described above.

As a result, even when the hydrodynamic bearing device is subjected to external impact, vibration, or the like, the flow of lubricant from the communicating path toward the bearing seal portion can be blocked by the flow suppressor and dispersed in the circumferential direction. Consequently, the lubricant is kept from flowing linearly from the communicating path to the bearing seal portion, leakage of the lubricant from the bearing seal portion is effectively suppressed, and a hydrodynamic bearing device with superior impact resistance can be obtained.

The hydrodynamic bearing device pertaining to the second invention is the hydrodynamic bearing device pertaining to the first invention, wherein the flow suppressor is a convex portion disposed between the communicating path and the bearing seal portion.

Here, the convex portion formed on the end face of the sleeve on the bearing seal side, or on a face opposite the sleeve on a cover member attached on this end face side, is used as the flow suppressor.

Consequently, the flow of lubricant that has flowed out from the communicating path when the hydrodynamic bearing device is subjected to impact, etc., toward the bearing seal portion can be hindered by the convex portion. As a result, the leakage of the lubricant from the bearing seal portion to the outside when the hydrodynamic bearing device is subjected to impact, etc., can be effectively prevented merely by employing a simple configuration in the form of a convex portion.

The hydrodynamic bearing device pertaining to the third invention is the hydrodynamic bearing device pertaining to the first invention, wherein the flow suppressor is disposed near the communicating path.

Here, the flow suppressor is provided near the communicating path and between the communicating path and the bearing seal portion.

Consequently, in the event of an impact, etc., the flow of lubricant coming out of the communicating path can be efficiently suppressed by the flow suppressor disposed near the communicating path. Also, providing the flow suppressor near the communicating path avoids the problem of hindering the behavior of the lubricant near the bearing seal portion. As a result, this further enhances the effect of providing the flow suppressor, namely, that of dispersing in the circumferential direction the flow of lubricant from the communicating path to the bearing seal portion, and at the same time eliminates adverse effect to the bearing component by having the lubricant flow more smoothly near the bearing seal portion.

The hydrodynamic bearing device pertaining to the fourth invention is the hydrodynamic bearing device pertaining to the first invention, wherein the flow suppressor is substantially C-shaped in plan view and is disposed so as to surround the periphery of the communicating path on the bearing seal portion side.

Here, a member that protrudes in a substantially C shape in plan view and is formed on the end face on the bearing seal side of the sleeve, or on a face opposite the sleeve on a cover member attached on this end face side, is used as the flow suppressor.

Consequently, the sudden and local flow of lubricant that has moved in from the communicating path toward the bearing seal portion when the hydrodynamic bearing device is subjected to impact, etc., can be hindered by the substantially C-shaped member formed so as to surround the outer periphery of the communicating path on the bearing seal portion side. As a result, the flow of lubricant from the communicating path toward the bearing seal portion when the hydrodynamic bearing device is subjected to impact or the like is more effectively suppressed, and the lubricant can be prevented from leaking out of the bearing seal portion.

The hydrodynamic bearing device pertaining to the fifth invention is the hydrodynamic bearing device pertaining to the first invention, wherein the flow suppressor has a cushioning portion at the end in the circumferential direction of a circle whose center is the rotational axis of the shaft member.

Here, for example, both ends in the circumferential direction of the flow suppressor formed as a convex portion are formed in a tapered or other such smooth shape.

Consequently, when the hydrodynamic bearing device is subjected to impact, etc., the lubricant coming out of the communicating path runs into the flow suppressor and is split to the left and right, and even when the shaft rotation, etc., causes the lubricant to flow in the circumferential direction, the generation of eddies in the lubricant can be suppressed. As a result, by avoiding the admixture of bubbles into the lubricant, the leakage of the lubricant to the outside can be more effectively suppressed. The cushioning portion does not necessarily have to be provided to both ends, and may be disposed on just the front or rear side in the rotational direction of the shaft.

The hydrodynamic bearing device pertaining to the sixth invention is the hydrodynamic bearing device pertaining to the first invention, wherein the flow suppressor is shaped such that its length in the circumferential direction is greater than its length in the direction in which the communicating path and the bearing seal portion are linked by the shortest distance.

Here, the length of the flow suppressor in the circumferential direction is specified by comparison with the length in the direction in which the communicating path and the bearing seal portion are linked by the shortest distance.

Consequently, the portion from the communicating path toward the bearing seal portion is thoroughly covered by the flow suppressor, and a gap through which the lubricant flows can be ensured in the circumferential direction. Thus, the external dimensions of the bearing seal portion are kept to a minimum, while leakage of the lubricant to the outside can be suppressed more effectively.

The hydrodynamic bearing device pertaining to the seventh invention is the hydrodynamic bearing device pertaining to the first invention, wherein the flow suppressor is wider than the spacing of two external tangents that link the communicating path and the bearing seal portion.

Here, the flow suppressor is formed such that it is longer in the circumferential direction than two external tangents that link the outer periphery of the communicating path and the outer periphery of the bearing seal portion.

Consequently, the lubricant coming out of the communicating path does not flow linearly toward the bearing seal portion, and instead arrives at the bearing seal portion in a circuitous fashion. As a result, the lack of lubricant caused by fluctuation in the liquid level of the lubricant can be compensated for, so leakage of the lubricant can be more effectively suppressed.

The hydrodynamic bearing device pertaining to the eighth invention is the hydrodynamic bearing device pertaining to the first invention, further comprising an enlarged space portion flanking the communicating path and on the opposite side of the flow suppressor in the radial direction of a circle whose center is the rotational axis of the shaft member, with which the gap becomes larger than in other portions.

Here, an enlarged space portion, which is a large space constituted so that the flow of lubricant in the circumferential direction will be easier, is further provided on the opposite side of the flow suppressor to the communicating path in the radial direction.

Consequently, the sudden flow of the lubricant toward the bearing seal portion side can be suppressed by guiding the lubricant coming out of the communicating path to the enlarged space portion side, which has low flow resistance. The lubricant that flows out of the communicating path at high pressure is released all at once into the enlarged space portion provided on the opposite side from the bearing seal portion, so leakage of the lubricant can be more effectively suppressed.

The hydrodynamic bearing device pertaining to the ninth invention is the hydrodynamic bearing device pertaining to the first invention, wherein the flow suppressor is a circular convex portion disposed between the communicating path and the bearing seal portion via a flow gap narrower than a gap near the communicating path.

Here, the circular convex portion formed on the end face of the sleeve on the bearing seal side, or on a face opposite the sleeve on a cover member attached on this end face side, is used as the flow suppressor.

Consequently, the rapid flow of lubricant that has flowed out from the communicating path when the hydrodynamic bearing device is subjected to impact, etc., toward the bearing seal portion can be suppressed by the circular convex portion. As a result, the leakage of the lubricant from the bearing seal portion to the outside when the hydrodynamic bearing device is subjected to impact, etc., can be effectively prevented merely by employing a simple configuration in the form of a convex portion.

The spindle motor pertaining to the tenth invention is equipped with the hydrodynamic bearing device pertaining to the first invention.

Here, the above-mentioned hydrodynamic bearing device is mounted in a spindle motor.

Consequently, the linear flow of lubricant from the communicating path to the bearing seal portion is eliminated, the leakage of lubricant from the bearing seal portion is effectively suppressed, and a spindle motor with superior impact resistance can be obtained.

The information device pertaining to the eleventh invention is equipped with the spindle motor pertaining to the tenth invention.

Here, the above-mentioned spindle motor is mounted in an information device such as a recording and reproducing apparatus.

Consequently, the linear flow of lubricant from the communicating path to the bearing seal portion is eliminated, the leakage of lubricant from the bearing seal portion is effectively suppressed, and an information device with superior impact resistance can be obtained.

### BRIEF DESCRIPTION OF DRAWINGS

FIG. 1 is a side cross section illustrating the internal configuration of the HDD pertaining to an embodiment of the present invention;

FIG. 2 is a side cross section illustrating the internal configuration of the hydrodynamic bearing device mounted in the HDD shown in FIG. 1;

FIG. 3A is a side cross section illustrating the configuration of a cover included in the hydrodynamic bearing device in FIG. 2, and FIG. 3B is a bottom plan view of this cover;

FIG. 4 is a bottom plan view of the cover included in the hydrodynamic bearing device pertaining to another embodiment of the present invention;

FIG. 5A is a side cross section illustrating the configuration of the hydrodynamic bearing device pertaining to another embodiment of the present invention, and FIG. 5B is a bottom plan view illustrating the configuration of the cover included in this hydrodynamic bearing device;

FIG. 6 is a partially cut-away oblique view illustrating the configuration of the cover pertaining to yet another embodiment of the present invention;

FIG. 7A is a bottom plan view of the cover pertaining to yet another embodiment of the present invention, and FIG. 7B is a partially cut-away oblique view of this cover;

FIG. 8A is a side cross section illustrating the configuration of the hydrodynamic bearing device pertaining to yet another embodiment of the present invention, and FIG. 8B is a bottom plan view illustrating the configuration of the cover included in this hydrodynamic bearing device;

FIG. 9A is a side cross section illustrating the configuration of the hydrodynamic bearing device pertaining to yet another embodiment of the present invention, and FIG. 9B is a detailed view illustrating the configuration of the flow suppressing wall included in this hydrodynamic bearing device;

FIG. 10 is a side cross section illustrating the configuration of the hydrodynamic bearing device pertaining to yet another embodiment of the present invention;

FIG. 11A is a plan view of the inner sleeve and outer sleeve included in the hydrodynamic bearing device pertaining to yet another embodiment of the present invention, and FIG. 11B is a side cross section illustrating the configuration of this hydrodynamic bearing device; and

FIG. 12 is a side cross section illustrating the internal configuration of the hydrodynamic bearing device pertaining to yet another embodiment of the present invention

FIG. 13 is a side cross section illustrating the internal configuration of the hydrodynamic bearing device pertaining to yet another embodiment of the present invention

FIG. 14A is a side cross section illustrating the state within a conventional hydrodynamic bearing device when the hydrodynamic bearing device has been dropped, FIG. 14B is a side cross section illustrating the state within the hydrodynamic bearing device at the instant the base component stops, and FIG. 14C is a side cross section illustrating the state within the hydrodynamic bearing device at the instant the rotor component has been magnetically attracted to the base component.

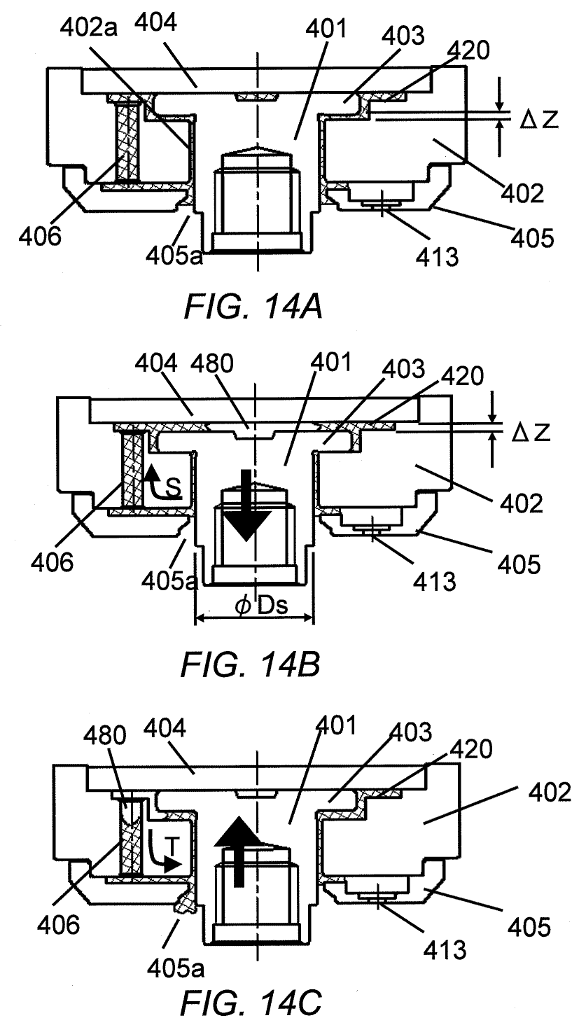

### DETAILED DESCRIPTION OF THE PREFERRED EMBODIMENTS

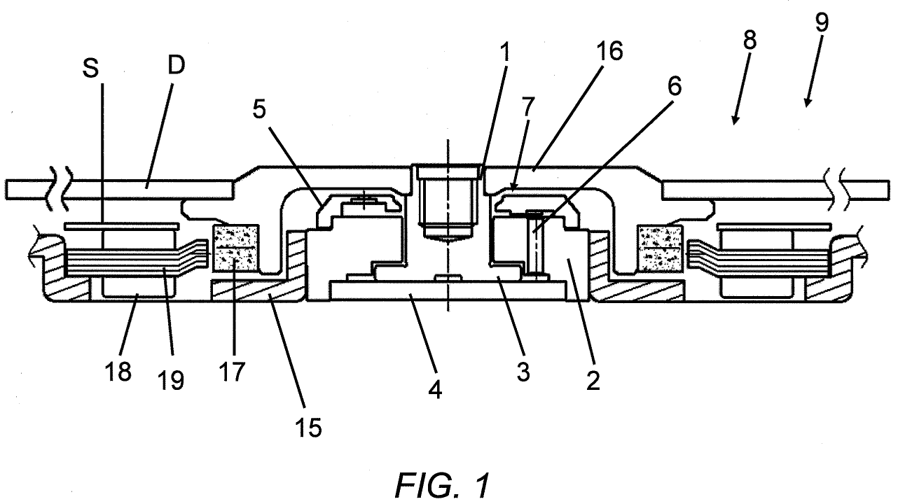

An HDD (information device) 9 equipped with a spindle motor 8 including a bearing component (hydrodynamic bearing device) 7 pertaining to an embodiment of the present invention will now be described through reference to FIGS. 1 to 3.

Overall Configuration of HDD 9

As shown in FIG. 1, the HDD 9 pertaining to this embodiment internally includes a plurality of recording and reproduction heads (not shown), and is equipped with a spindle motor 8. The recording and reproducing heads write information to a recording disk (recording medium) D, or reproduce information that has already been written.

The disk D is a recording medium in the form of a disk that is attached to the HDD 9 and has a diameter of 0.85 inch, 1.0 inch, 1.8 inches, 2.5 inches, or 3.5 inches, for example.

The spindle motor 8 is a device that serves as a rotational drive source for the rotary drive of the recording disk D, and is equipped with a rotor magnet 17, a stator coil 18, a stator core 19, a magnetic shield plate S, a bearing component (hydrodynamic bearing device) 7, etc.

Description of Members Constituting the Spindle Motor 8

The rotor magnet 17 is a member in the form of a circular ring, in which adjacent magnetic poles are disposed alternately as N and S poles, consists of an Nd—Fe—B-based resin magnet, for example, and is mounted on a magnet holder of a rotor hub 16.

The stator core 19 has a plurality of protruding poles disposed at substantially equiangular spacing in the radial direction, and the stator coils 18 are wound around each of these protruding poles. The stator core 19 imparts a magnetic flux generated by the flow of current to the stator coils 18, and thereby imparts rotational force to the rotor magnet 17 disposed opposite the stator core 19 on the inner peripheral side.

The magnetic shield plate S is attached so as to cover the upper part of the stator core 19, and is a stainless steel magnetic piece with a thickness of about 0.1 mm, for preventing magnetic leakage to the outside.

The bearing component 7 is a hydrodynamic bearing device included in the spindle motor 8, and is disposed near the center of the spindle motor 8.

Description of Members Constituting the Bearing Component 7

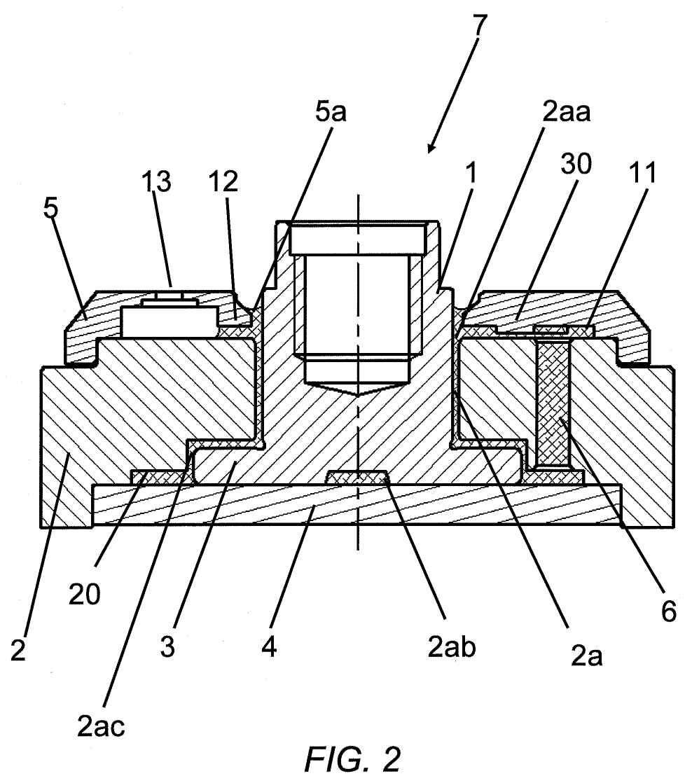

As shown in FIG. 2, the bearing component 7 is constituted to include a shaft (shaft member, rotary axis) 1, a sleeve (sleeve member) 2, a thrust flange (shaft member) 3, a thrust plate (sleeve member) 4, a base 15, and a rotor hub 16.

The shaft 1 is a member serving as the rotary axis of the bearing component 7, is inserted in a bearing hole 2a of the sleeve 2, and is formed from stainless steel.

The sleeve 2 supports the shaft 1 and the thrust flange 3, which are inserted in the bearing hole 2a, in a state of being capable of relative rotation. A thrust hydrodynamic groove (not shown) for generating dynamic pressure is formed on the face of the thrust flange 3 that is opposite the thrust plate 4 in the axial direction, and a thrust hydrodynamic generator is formed between the thrust flange 3 and the thrust plate 4. Similarly, a radial hydrodynamic groove (not shown) for generating dynamic pressure is formed on radially opposing faces between the shaft 1 and the sleeve 2, and a radial hydrodynamic generator is formed between the shaft 1 and the sleeve 2. The sleeve 2 is formed from brass or another such copper alloy, and its surface has undergone electroless nickel plating. Furthermore, the sleeve 2 has a closed end 2ab on the thrust plate 4 side in the axial direction, an open end 2aa on the opposite side, and a communicating hole (communicating path) 6 that communicates between the closed end 2ab side and the open end 2aa side. A cover 5 is attached on the open end 2aa side of the sleeve 2 so as to form a specific gap from the top end face of the sleeve 2.

The thrust flange 3 is formed from stainless steel and is either integrally machined from the shaft 1 or is fixed thereto by press-fitting, adhesive bonding or welding. The thrust flange 3 is fitted to a large diameter hole portion 2ac of the sleeve 2.

The thrust plate 4 is attached to the bottom end face of the sleeve 2 in the axial direction, and forms the closed end of the sleeve 2.

The cover 5 is a substantially disk-shaped member attached so as to cover the top end face (the open end 2aa side) of the sleeve 2, and has an open portion in its center in which the shaft 1 is inserted. Also, a vent hole 13 that passes through to the top end face side of the sleeve 2 is formed on the opposite side of the cover 5 in the radial direction with respect to the communicating hole 6 formed in the sleeve 2. Further, the cover 5 has a introduction gap 11 and the flow suppressing wall (flow suppressor, convex portion) 30 on the inner face side opposite the open end 2aa of the sleeve 2. The detailed configuration of the cover 5, including this flow suppressing wall 30, will be described below.

The base 15 is formed from magnetic stainless steel or steel plate, has undergone electroless nickel plating, and constitutes the portion on the stationary side of the spindle motor 8. Also, the bearing component 7 is fixed near the center of the base 15. If the HDD is 2.5 inches or larger in size, a base made of diecast aluminum can also be used.

The rotor hub 16 is formed from a magnetic stainless steel material, is fixed so as to be fitted to the top end of the shaft 1, and rotates integrally with the shaft 1. Also, the rotor hub 16 has a center hole in which the top end of the shaft 1 is inserted, a magnet holder to which the rotor magnet 17 is attached, and a disk placement face on which the recording disk D is placed.

In this embodiment, of the constituent members discussed above, an inner peripheral seal portion (bearing seal portion) 12 is formed on the outer peripheral face side of the shaft 1, and in a gap portion formed between the cover 5 and the end face of the sleeve 2 on the open end 2aa side in the axial direction. Consequently, during normal operation, the lubricant 20 held in the bearing component is drawn by capillary action into the bearing, and this prevents it from leaking from an inner peripheral opening 5a to the outside.

Configuration of the Cover 5

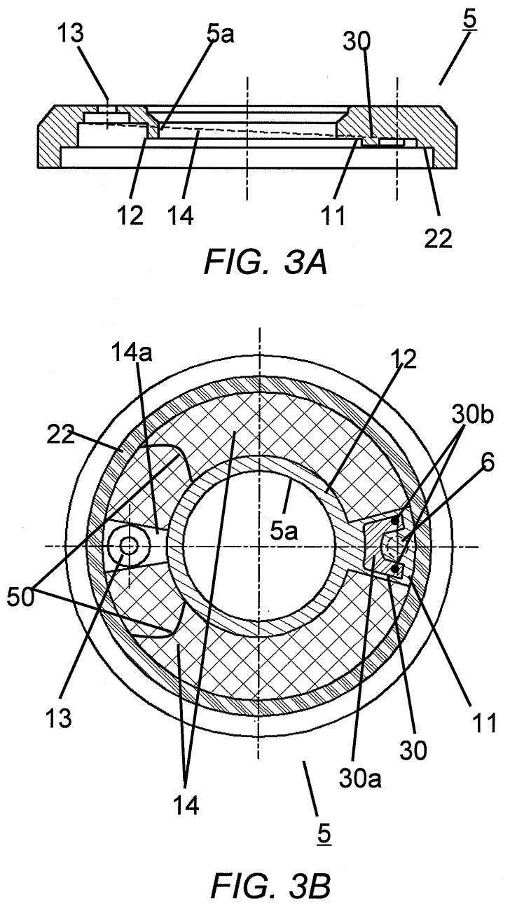

As shown in FIGS. 3A and 3B, the cover 5 is aligned in phase with the top end face of the sleeve 2, after which it is joined by adhesive bonding or the like at a contact portion 22. The introduction gap 11, the inner peripheral seal portion 12, a fluid reservoir space 14, and the flow suppressing wall 30 are formed on the face of the cover 5 that is opposite the open end 2aa of the sleeve 2.

The introduction gap 11 is formed between the inner face of the cover 5 that is opposite the sleeve 2, and the end face of the sleeve 2 on the open end 2aa side. The introduction gap 11 bends the flow of the lubricant 20, which would otherwise flow toward the inner peripheral seal portion 12 blocked off by the flow suppressing wall 30 (discussed below), and forms a gap for guiding to the inner peripheral seal portion 12 side with the flow suppressing wall 30 in the circumferential direction.

The inner peripheral seal portion 12 is formed in a substantially circular shape on the open end 2aa side of the sleeve 2 and along the outer peripheral portion of the shaft 1, and uses capillary action to prevent the lubricant 20 held in the bearing from flowing outside the bearing. In areas other than the introduction gap 11 and the inner peripheral seal portion 12, a concave portion is provided inside the cover 5 so that it may have larger gap space than the introduction gap 11 and the inner peripheral seal portion 12. In this way, a fluid reservoir space 14 which can store lubricant 20 is formed. And the fluid reservoir space 14 communicates the introduction gap 11 and the vent hole 13 in the circumferential direction. The fluid reservoir space 14 forms the maximum space portion 14a which has the largest gap near the vent hole 13. The fluid reservoir space 14 is formed so that the gap may become small toward the communicating hole 6. Namely, the upper end surface and the internal surface of the cover 5 of the sleeve 2 incline relatively in the circumferential direction so that the distance between the upper end surface of the sleeve 2 and the internal surfaces of the cover 5 may become large gradually toward the maximum space portion 14a rather than the communicating hole 6.

The gap between the introduction gap 11 and the end face of the sleeve 2 in the axial direction of the inner peripheral seal portion 12 may be about 20 to 100 μm.

The fluid reservoir space 14 is normally formed in the bearing space excluding the space near the vent hole 13, etc., in order to hold the lubricant 20 in the bearing.

The flow suppressing wall 30 is a convex portion formed facing downward in the axial direction so as to protrude from the face of the cover 5 that is opposite the open end 2aa of the sleeve 2, and is formed so as to cover the space on the inside in the radial direction of the communicating hole 6 formed in the sleeve 2. The flow suppressing wall 30 is provided so as to substantially block off the space between the communicating hole 6 and the inner peripheral seal portion 12. Furthermore, the flow suppressing wall 30 is substantially C-shaped in plan view and is disposed so as to cover the inner peripheral seal portion 12 side of the communicating hole 6. This substantially C shape is made up of a front wall portion 30a and a pair of side wall portions 30b. The size of the gap between the end face of the sleeve 2 and the flow suppressing wall 30 may be 0 μm, or may be approximately 50 μm or less, and preferably approximately 30 μm or less, and even more preferably 10 μm or less.

When the HDD 9 of this embodiment is subjected to a falling impact or the like from the outside, the shaft 1 inserted in the bearing hole 2a of the sleeve 2 moves relatively in the axial direction with respect to the sleeve 2. If the relative position of the shaft 1 here changes greatly in a short time, a bubble may be generated or admixed in the lubricant 20. The lubricant 20 in which this bubble has been generated or admixed flows all at once from the communicating hole 6, which has a low flow resistance, to the open end 2aa side of the sleeve 2. The lubricant 20 that flows out here hits the flow suppressing wall 30 formed near the communicating hole 6, which blocks its flow to the inner peripheral seal portion 12 side, so the flow has to go around in the circumferential direction, after which the flow moves toward the inner peripheral seal portion 12.

Consequently, the sudden flow of the lubricant 20 from the communicating hole 6 straight toward the inner peripheral seal portion 12 is suppressed. Also, since everything from the communicating hole 6 to the inner peripheral seal portion 12 is connected by the introduction gap 11, there is no interruption of supply of the lubricant 20 to the inner peripheral seal portion 12.

Features of the Bearing Component 7

(1)

As shown in FIG. 2, the bearing component 7 pertaining to this embodiment comprises the shaft 1, the sleeve 2 having the bearing hole 2a in which the shaft 1 is inserted, the communicating hole 6 formed in the sleeve 2, the lubricant 20 held in the gap between the shaft 1 and the sleeve 2, etc., the inner peripheral seal portion 12 that holds the lubricant 20 inside the bearing component 7, and the flow suppressing wall 30 formed between the communicating hole 6 and the inner peripheral seal portion 12. As shown in FIGS. 3A and 3B, the flow suppressing wall 30 hinders the flow of the lubricant 20 coming out of the communicating hole 6 toward the inner peripheral seal portion 12, and disperses it in the circumferential direction.

Consequently, even if the device is subjected to an external impact or the like that causes the shaft 1 to move suddenly relative to the sleeve 2, and the lubricant 20 to flow all at once from the communicating hole 6, the linear flow of the lubricant 20 toward the inner peripheral seal portion 12 can be dispersed in the circumferential direction by the flow suppressing wall 30 disposed near the communicating hole 6. As a result, leakage of the lubricant 20 from the inner peripheral seal portion 12 can be effectively suppressed, and a bearing component 7 with superior impact resistance can be obtained.

(2)

With the bearing component 7 pertaining to this embodiment, as shown in FIG. 3A, a convex portion formed on the face of the cover 5 that is opposite the sleeve 2 is used as the flow suppressing wall 30.

Consequently, a flow suppressing wall 30 that has a relatively simple shape can control the flow of the lubricant 20 from the communicating hole 6, and can suppress linear flow toward the inner peripheral seal portion 12. As a result, even if there is an external impact or the like, the lubricant 20 coming all at once out of the communicating hole 6 can be effectively prevented from leaking out from the inner peripheral seal portion 12.

(3)

With the bearing component 7 pertaining to this embodiment, as shown in FIG. 3B and elsewhere, the flow suppressing wall 30 is provided near the communicating hole 6.

Consequently, even if the lubricant 20 flows out of the communicating hole 6 in the event of an impact or the like, the flow suppressing wall 30 disposed nearby will be able to suppress flow to the inner peripheral seal portion 12 side. Also, providing the flow suppressing wall 30 does not suppress the flow of the lubricant 20 near the inner peripheral seal portion 12. As a result, the lubricant 20 can be effectively prevented from leaking out from the inner peripheral seal portion 12 in the event of an impact or the like, without decreasing the performance of the bearing component 7.

(4)

With the bearing component 7 pertaining to this embodiment, as shown in FIG. 3B, a member that is substantially C shaped in plan view is used as the flow suppressing wall 30. The flow suppressing wall 30 is disposed so that the opening in the substantially C-shaped member faces to the outside in the radial direction.

Consequently, even if the lubricant 20 flows out of the communicating hole 6 in the event of an external impact or the like, the substantially C-shaped flow suppressing wall 30 that surrounds the outer peripheral part on the inner peripheral seal portion 12 side of the communicating hole 6 will be able to hinder linear flow to the inner peripheral seal portion 12 side. As a result, leakage of the lubricant 20 coming out of the communicating hole 6 from the inner peripheral seal portion 12 can be effectively prevented, and a bearing component 7 with superior impact resistance can be obtained.

(5)

With the spindle motor 8 pertaining to this embodiment, as shown in FIG. 1, the above-mentioned bearing component 7 is mounted as a hydrodynamic bearing device.

Consequently, as discussed above, even in the event of a falling impact or the like, the lubricant 20 coming out of the communicating hole 6 can be prevented from leaking out from the inner peripheral seal portion 12, and a spindle motor 8 with superior impact resistance can be obtained.

(6)

The HDD 9 pertaining to this embodiment is equipped with the above-mentioned spindle motor 8, as shown in FIG. 1.

Consequently, as discussed above, even in the event of a falling impact or the like, the lubricant 20 coming from the communicating hole 6 can be prevented from leaking out of the inner peripheral seal portion 12, and the HDD 9 with superior impact resistance can be obtained.

### Other Embodiments

A preferred embodiment of the present invention was described above, but the present invention is not limited to the above embodiment, and various modifications are possible without departing from the gist of the invention.

(A)

In the above embodiment, an example was given in which the substantially C-shaped flow suppressing wall 30 was disposed near the communicating hole 6 to suppress leakage from the inner peripheral seal portion 12 of the lubricant 20 flowing out of the communicating hole 6, but the present invention is not limited to this.

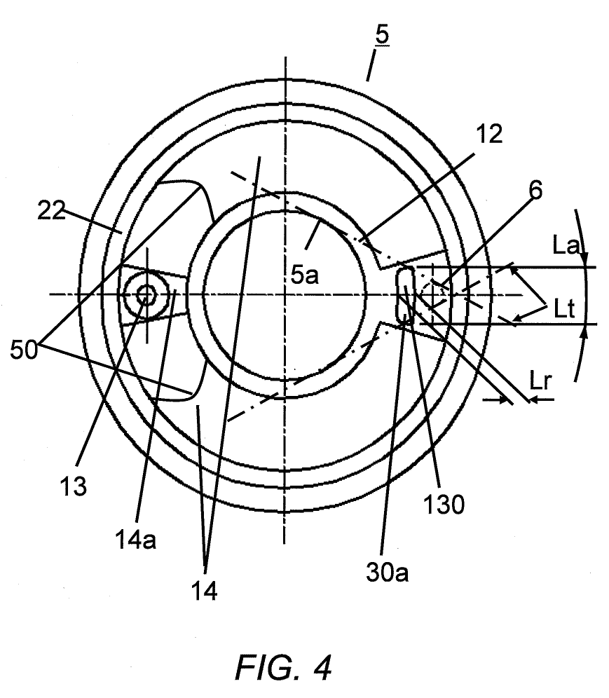

For instance, as shown in FIG. 4, a flow suppressing wall 130 including only the front wall portion 30a that is substantially I-shaped in plan view may be disposed near the inner peripheral seal portion 12 side of the communicating hole 6.

Here, the flow suppressing wall 130 is formed such that its width in the circumferential direction is greater than two external tangents Lt that link the outer periphery of the communicating hole 6 and the outer periphery of the inner peripheral seal portion 12. Thus, a situation in which the lubricant 20 coming out of the communicating hole 6 reaches the inner peripheral seal portion 12 in linear fashion can be effectively avoided. The distance until the inner peripheral seal portion 12 is reached is extended so that the flow must go around in the circumferential direction before reaching the inner peripheral seal portion 12, and the viscosity of the lubricant 20 as it flows attenuates the force with which it attempts to leak to the outside. As a result, leakage of the lubricant 20 to the outside can be effectively prevented.

Furthermore, in FIG. 4, the length La of the flow suppressor in the circumferential direction is greater than the length Lr in the direction in which the communicating path and the bearing seal portion are linked by the shortest distance (the radial direction in FIG. 4). Consequently, the portion from the communicating path toward the bearing seal portion is thoroughly covered by the flow suppressor, and a gap through which the lubricant flows can be ensured in the circumferential direction. Thus, the external dimensions of the bearing seal portion are kept to a minimum, while leakage of the lubricant to the outside can be suppressed more effectively.

(B)

In the above embodiment, an example was given in which a situation in which the lubricant 20 coming out of the communicating hole 6 directly toward the inner peripheral seal portion 12 was avoided by the flow suppressing wall 30 disposed near the communicating hole 6. However, the present invention is not limited to this.

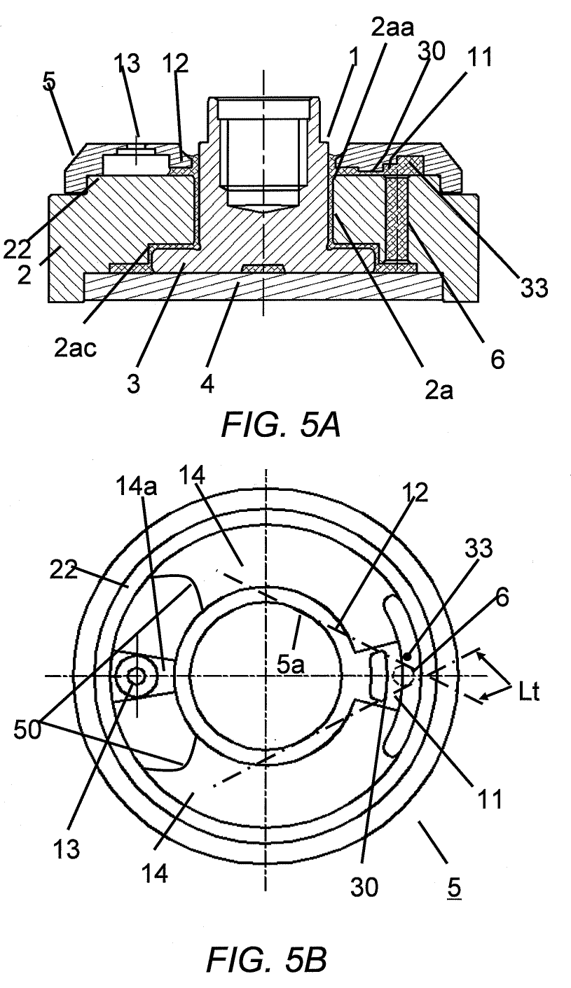

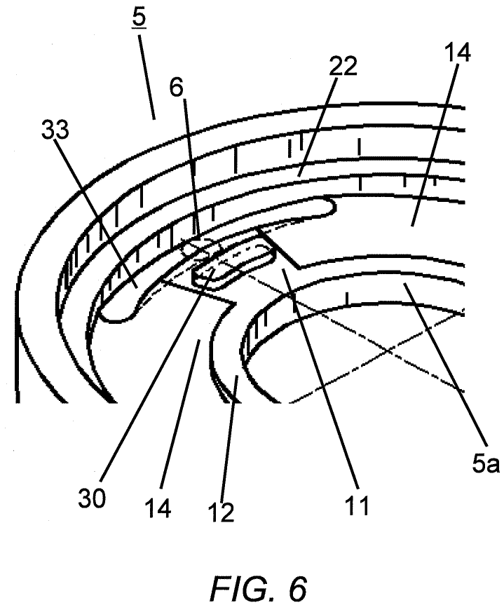

For instance, as shown in FIGS. 5A and 5B and FIG. 6, in addition to the above-mentioned flow suppressing wall 30, an enlarged space portion 33, with which the gap with the top end face of the sleeve 2 is larger in the axial direction, may also be provided on the opposite side (outer peripheral side) of the flow suppressing wall 30 to the communicating hole 6.

As shown in FIG. 5A, the enlarged space portion 33 is formed by a concave portion provided to a face of the cover 5 on the sleeve 2 side. Also, as shown in FIGS. 5B and 6, the enlarged space portion 33 is formed such that in plan view it touches part of the outer peripheral side of the communicating hole 6 in the sleeve 2.

As shown in FIGS. 5A and 6, the enlarged space portion 33 here is such that its gap with the sleeve 2 in the axial direction is substantially constant, and the connected portion between the tapered face of the fluid reservoir space 14 and the enlarged space portion 33 is smoothly connected.

Consequently, the lubricant 20 coming out of the communicating hole 6 tries to flow toward the outer peripheral side where the gap is larger in the axial direction, and this forms a flow toward the circumferential direction on the outer peripheral side of the communicating hole 6. As a result, the flow from the communicating hole 6 straight toward the inner peripheral seal portion 12 is more effectively dispersed, and leakage of the lubricant 20 to the outside can be prevented.

(C)

In the above embodiment, an example was given in which the flow suppressing wall 30 was disposed in a region near the communicating hole 6 between the communicating hole 6 and the inner peripheral seal portion 12, but the present invention is not limited to this.

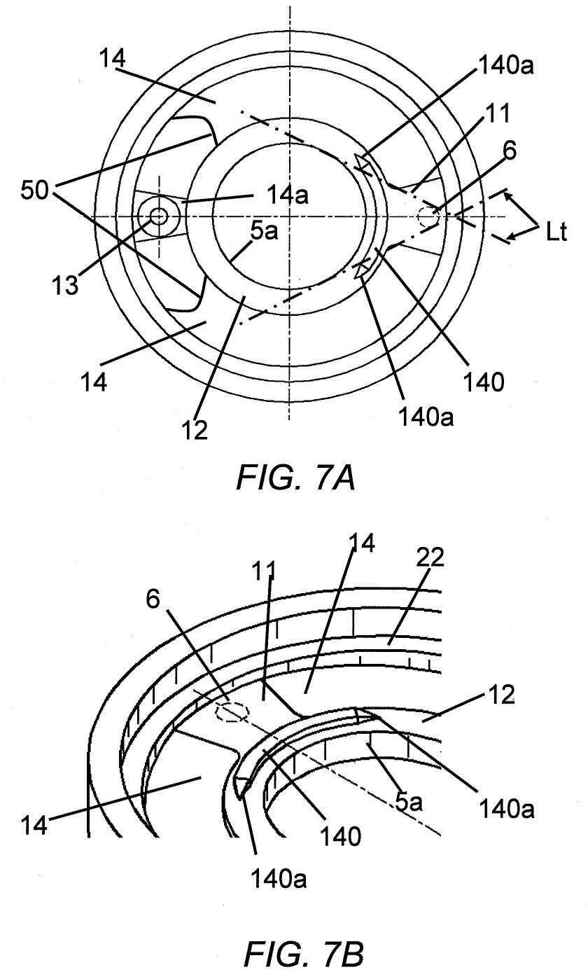

For instance, as shown in FIGS. 7A and 7B, a flow suppressing wall 140 may be provided at a position closer to the inner peripheral seal portion 12.

With this configuration, the lubricant 20 near the inner peripheral seal portion 12 turns along with the rotation of the shaft 1, so there is the risk that an eddy or cavity will be generated before or after the flow suppressing wall 140 in the rotational phase direction. Accordingly, with this embodiment, as shown in FIGS. 7A and 7B, tapered connectors (cushioning portion) 140a that drop off smoothly in a downward diagonal direction toward the outside in the circumferential direction are provided at both ends of the flow suppressing wall 140 in the circumferential direction. Consequently, even when the flow suppressing wall 140 is provided closer to the inner peripheral seal portion 12, the generation of eddies or cavities is prevented, and bubbles can be prevented from being admixed into the lubricant 20. A tapered connector 140a may also be provided to just one side with respect to the rotational direction, such as just to the rear side.

Also, even with the configuration shown in FIG. 7A and so on, as discussed above, the flow suppressing wall 140 in plan view preferably extends more to the outside in the circumferential direction than the two external tangents Lt that link the outer periphery of the communicating hole 6 and the outer periphery of the inner peripheral seal portion 12. Consequently, the lubricant 20 coming out of the communicating hole 6 is prevented from leaking out from the inner peripheral seal portion 12.

(D)

In the above embodiment B, an example was given in which the enlarged space portion 33 was provided on the opposite side of the flow suppressing wall 30 in the radial direction to the communicating hole 6, but the present invention is not limited to this.

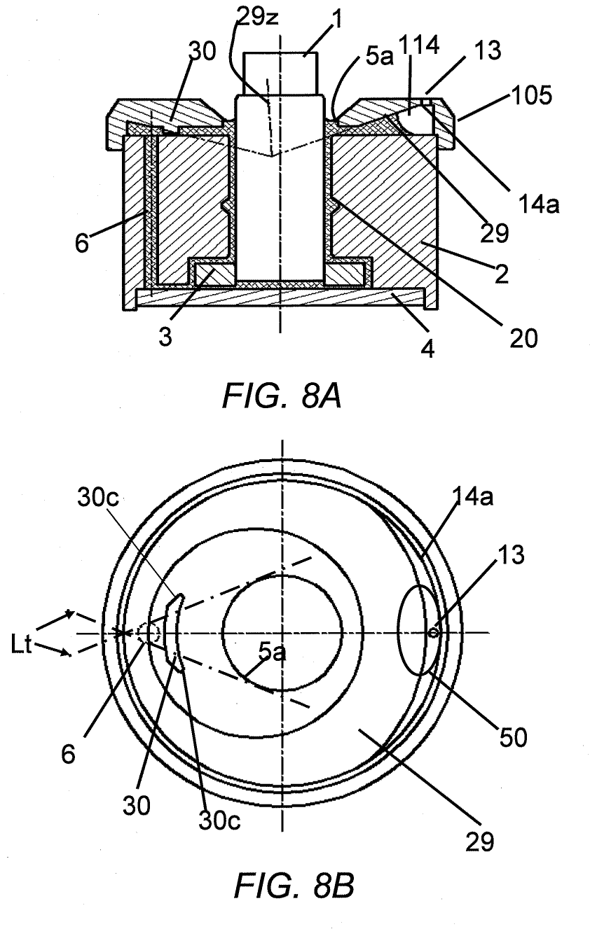

For instance, as shown in FIGS. 8A and 8B, a lubricant reservoir space 114 with which the gap becomes larger toward the outside in the radial direction because of a tapered face 29 formed on the inner face side of a cover 105 may be provided to the cover 105 so as to communicate with the vent hole 13 provided at a position on the opposite side of the communicating hole 6 to the shaft 1.

Specifically, the lubricant reservoir space 114 is formed so that the gap widens in the axial direction from the inner periphery toward the outer periphery, and communicates from the communicating hole 6 to the vent hole 13 in the circumferential direction. Furthermore, it is formed so that the gap in the axial direction widens toward the vent hole 13. Also, the lubricant reservoir space 114 is narrowest on the communicating hole 6 side so as to produce capillary action, with its dimension here being about 0.04 to 0.06 mm. To form the lubricant reservoir space 114 in a shape such as this, the tapered face 29 can be in any shape desired, but as shown in FIG. 8A, it may have a conical shape in which the rotational symmetry axis is the inclined axis 29z, which is inclined to the axis of the shaft 1.

The gap between the top end face of the sleeve 2 and the tapered face 29 of the cover 105 gradually widens toward the outer periphery in the radial direction, and near the outer periphery of the sleeve 2, the dimension is large enough that capillary action will not occur (such as about 0.15 to 0.25 mm). The lubricant reservoir space 114 is formed, for example, with an inside diameter of 3.2 to 3.8 mm, an outside diameter of 5.5 to 6.3 mm, a minimum gap of 0.03 to 0.15 mm, and a maximum gap of about 0.2 to 0.3 mm. The vent hole 13 has a diameter of about 0.2 to 1.0 mm, for example. A concave portion may be formed as a cushioning space and by a countersunk hole at the place where the vent hole 13 is provided. As a result, even if there is a rise in the temperature of the installation environment when the lubricant 20 is at its full level, for example, the surface of the lubricant 20 will be contained within the concave portion, and the lubricant 20 will be prevented from leaking out from the vent hole 13. The countersink dimensions are, for example, about 0.6 to 1.2 mm in diameter and 0.1 to 0.3 mm in depth.

Also, in the above embodiment, the vent hole 13 communicating with the outside air is provided at a place that, when the cover 105 is viewed in the axial direction, is 180 degrees opposite around the axis of the shaft 1 with respect to the communicating hole 6. Further, just one communicating hole 6 and one vent hole 13 may be provided, or a plurality of each may be provided.

Also, the inner peripheral face of the cover 105 opposite the shaft 1 is formed as an inclined face that widens toward the open side (upward) and narrows downward, so that the lubricant 20 is held in the inner peripheral opening 5a. Even if the lubricant 20 here should be reduced in volume by evaporation or the like, so that there is a change in the position of the liquid level of the lubricant 20 in the lubricant reservoir space 114, the design is such that the liquid level of the lubricant 20 in the inner peripheral opening 5a is balanced in the range of movement within the above-mentioned inclined face.

Here, the lubricant 20 that has moved downward due to the shape of the radial hydrodynamic groove, etc., circulates through the communicating hole 6 and comes back up, and flows into the lubricant introduction gap between the cover 105 and the top end face of the sleeve 2. The lubricant 20 containing bubbles here is divided into lubricant 20 that does contain bubbles and lubricant 20 that does not contain bubbles.

Consequently, bubbles are eliminated by separating the lubricant 20 containing bubbles into a part that does contain bubbles and a part that does not contain bubbles, which allows a hydrodynamic bearing device of higher reliability to be obtained.

(E)

In the above-mentioned embodiment, an example was given in which the flow suppressing wall 30, which protruded in a convex shape, was provided to the face of the cover 5 opposite the sleeve 2, but the present invention is not limited to this.

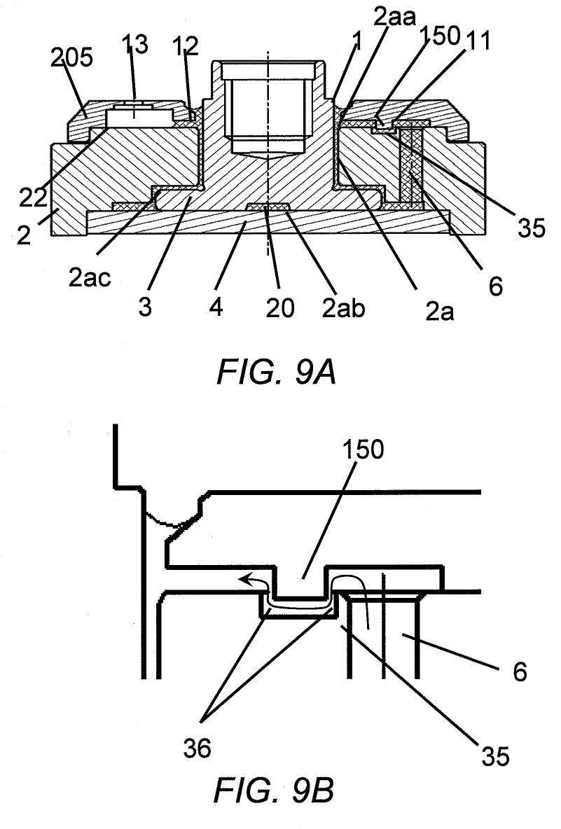

For example, as shown in FIGS. 9A and 9B, a concave portion 35 may be provided to a face of the sleeve 2 that is opposite a flow suppressing wall 150 formed on the inner face side of the cover 5.

In this case, a labyrinth 36 is formed by disposing the flow suppressing wall 150 so that it goes into this concave portion 35.

Consequently, the flow of the lubricant 20 from the communicating hole 6 straight toward the inner peripheral seal portion 12 is reliably suppressed, and has to go through the labyrinth 36 before reaching the inner peripheral seal portion 12, so the lubricant 20 can be prevented from leaking out from the inner peripheral seal portion 12.

(F)

In the above-mentioned embodiment, an example was given in which the flow suppressing wall 30 was provided to a face of the cover 5 that was opposite the top end face of the sleeve 2, but the present invention is not limited to this.

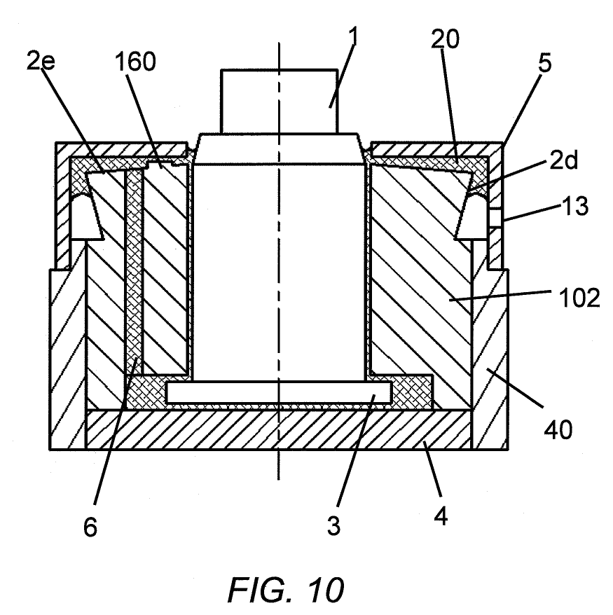

For example, as shown in FIG. 10, a flow suppressing wall 160 may be provided that protrudes in a convex shape from the top end face of a sleeve 102.

Here again, the lubricant 20 coming out of the communicating hole 6 is prevented from leaking out, and a hydrodynamic bearing device with superior impact resistance can be obtained.

(G)

In the above-mentioned embodiment, an example was given in which the communicating hole 6 was formed so as to communicate with the open end 2aa side and the closed end 2ab side of the sleeve 2, but the present invention is not limited to this.

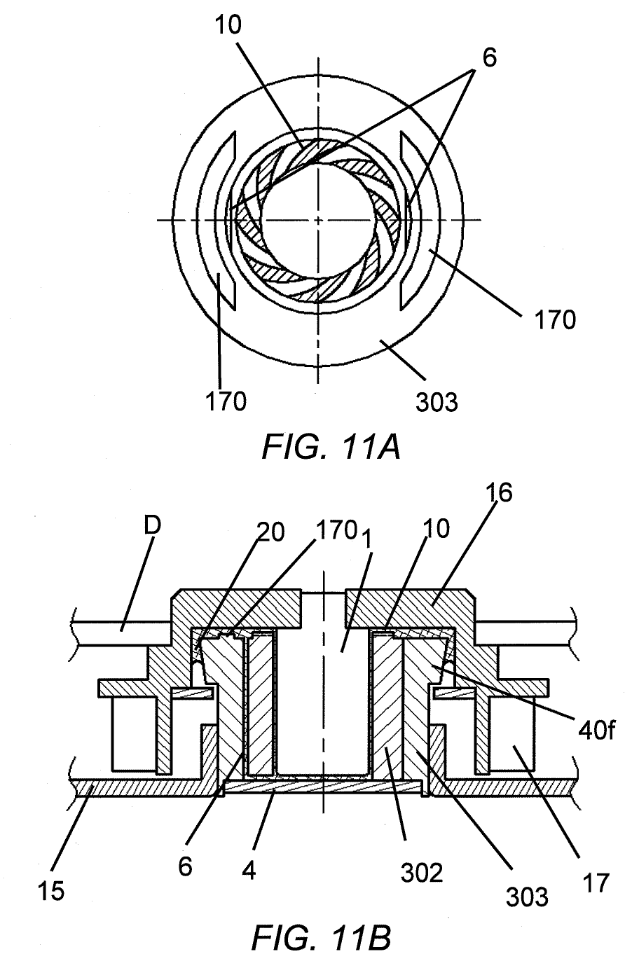

For example, as shown in FIGS. 11A and 11B, a sleeve member may be constituted by a sleeve 302 and a sleeve holder 303, and a shaft member may be constituted so as to include the shaft 1 and the rotor hub 16.

With this configuration, the communicating holes 6 are formed between the sleeve holder 303 and the sleeve 302 by providing a D-cut or a vertical groove in the outer periphery of the sleeve 302. The bearing seal portion here is constituted between the inner peripheral cylindrical part of the rotor hub 16 and the outer peripheral part of the sleeve member (the sleeve holder 303). A flow suppressing wall 170 is disposed between the communicating hole 6 and the bearing seal portion, so that the lubricant 20 coming out of the communicating hole 6 can be prevented from leaking out.

(H)

In the above-mentioned embodiment, an example was given in which a hydrodynamic bearing device (the bearing component 7) was mounted in a rotating shaft type of spindle motor 8, but the present invention is not limited to this.

For example, the present invention may also be applied to a hydrodynamic bearing device that is mounted in a fixed shaft type of spindle motor.

(I)

In the above-mentioned embodiment, an example was given of so-called inner rotor type of spindle motor 8 as a magnetic circuit including the rotor magnet 17 and the stator core 19, but the present invention is not limited to this.

For example, the present invention may also be applied to a hydrodynamic bearing device that is mounted in an outer rotor or axial gap type of spindle motor.

(J)

In the above-mentioned embodiment, an example was given in which the fluid reservoir space 14 was provided on the cover 5 side, but the present invention is not limited to this.

For example, the sleeve may be a sintered member or an article molded from a resin, and a metal mold may be configured so that the fluid reservoir space is provided on the sleeve side.

Similarly, the flow suppressing wall may be provided to the sleeve, a sleeve holder, etc. In this case, the phase relationship between the communicating path and the flow suppressing wall can be determined exclusively by the design of the mold, so there is no need to provide a special means for matching the phases of the two during assembly, and manufacturing costs can be kept lower.

(K)

In the above-mentioned embodiment, an example was given in which the communicating hole 6 was formed in the axial direction, but the present invention is not limited to this.

For example, with the configuration shown in FIG. 11, the opening of the communicating hole on the open end side of the sleeve member may face the outside in the radial direction at the outer peripheral part of the sleeve member. In this case, the same effects as above can be obtained by providing a flow suppressing wall between the opening of the communicating hole and the liquid level of the lubricant in the bearing seal portion.

(L)

In the above-mentioned embodiment, an example was given in which the flow suppressing wall was disposed only near the communicating hole, but the present invention is not limited to this.

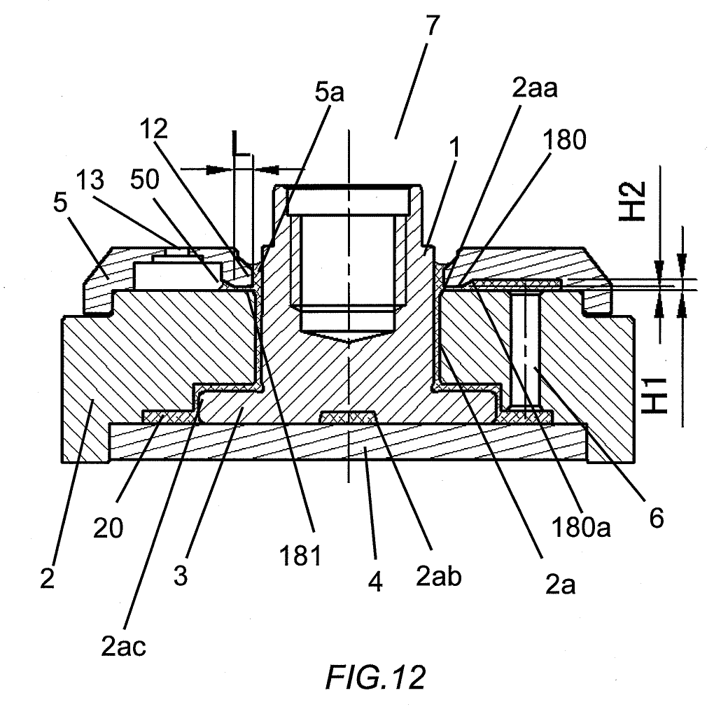

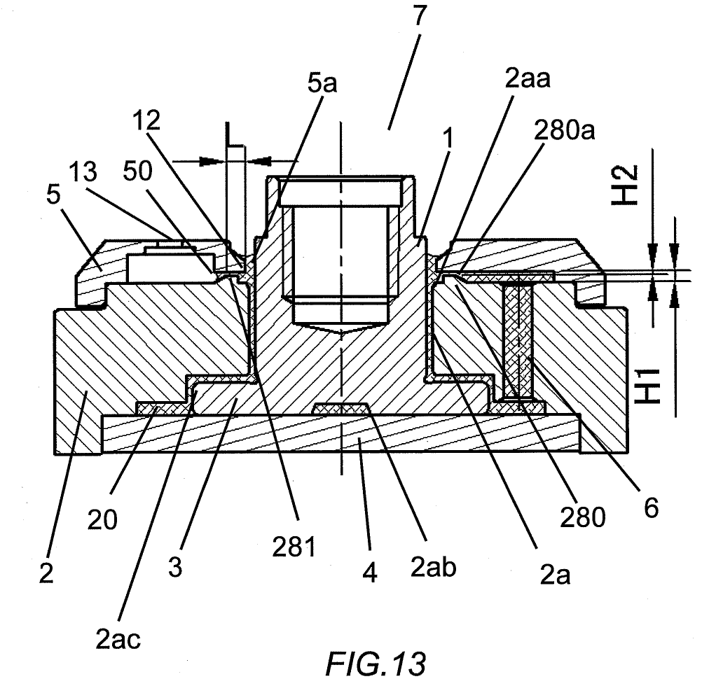

For instance, as shown in FIGS. 12 and 13, a circular flow suppressing wall 180 may be provided at a position between the communicating hole 6 and the inner peripheral seal portion 12 via a flow gap portion 181 narrower than a gap near the communicating hole 6. In the example shown in FIG. 12, the circular flow suppressing wall 180 is formed on the cover 5 side. On the other hand, in the example shown in FIG. 13, the circular flow suppressing wall 180 is formed on the sleeve 2 side. For example, if the axial direction distance H2 of this flow gap portion 181 is set to about 10-60 micrometers when the axial direction distance H1 near the communication hole 6 is 100 micrometers, the same effect as above-mentioned can be acquired. If H2 is about 10-60 micrometers, circulation of lubricant 20 will not be prevented between the communicating hole 6 and bearing hole 2a at the time of normal operation.

And change of the radius direction position of the gas liquid boundary surface 50 can be suppressed by providing taper portion 180a in the radius direction outside of this circular flow suppressing wall 180. Accordingly, since the gas liquid boundary surface 50 does not reach the inner peripheral opening 5a side even if radius direction length L of circular flow suppressing wall 180 is comparatively small, it can suppress more effectively that air bubbles enter into a bearing gap.

(M)

In the above-mentioned embodiment, an example was given in which the HDD 9 was an information device including a spindle motor in which the hydrodynamic bearing device pertaining to the present invention was mounted, but the present invention is not limited to this.

For example, the present invention can, of course, also be applied to an opto-magnetic disk device, optical disk device, Floppy® disk device, a rotary head device used for video cassette recorders or data streamers, a polygon motor device used for laser scanners, laser printers, and so forth, or another such information device.

### INDUSTRIAL APPLICABILITY

With the hydrodynamic bearing device pertaining to the present invention, even when it is subjected to a powerful impact from the outside, the lubricant coming out of the communicating hole can be prevented from leaking out from the bearing seal portion, so this device can be used in a wide range of applications for hydrodynamic bearing devices mounted in spindle motors that need to have impact resistance and are provided on the inside of a hard disk drive, etc., on which numerous stationary disks are mounted, or in mobile applications.

1. A hydrodynamic bearing device, comprising:
a shaft member;
a sleeve member that has a bearing hole which includes an open end and a closed end in the axial direction, with the shaft member being rotatably inserted in the bearing hole via a microscopic gap;
a communicating path in the sleeve member for communicating between a space inside the bearing on the closed end side and a space inside the bearing on the open end side;
a lubricant held at least in the microscopic gap and the communicating path;
a bearing seal portion that is disposed on the open end side of the sleeve member and more to the inner peripheral side or the outer peripheral side than the communicating path, and that suppresses leakage of the lubricant to outside the bearing by capillary action working between the bearing seal portion and the shaft member; and
a flow suppressor that is formed between the bearing seal portion and the communicating path and suppresses the flow of lubricant that has moved in from the communicating path toward the bearing seal portion.

2. The hydrodynamic bearing device according to claim 1,
wherein the flow suppressor is a convex portion disposed between the communicating path and the bearing seal portion.

3. The hydrodynamic bearing device according to claim 1,
wherein the flow suppressor is disposed near the communicating path.

4. The hydrodynamic bearing device according to claim 1,
wherein the flow suppressor is substantially C-shaped in plan view and is disposed so as to surround the periphery of the communicating path on the bearing seal portion side.

5. The hydrodynamic bearing device according to claim 1,
wherein the flow suppressor has a cushioning portion at the end in the circumferential direction of a circle whose center is the rotational axis of the shaft member.

6. The hydrodynamic bearing device according to claim 1,
wherein the flow suppressor is shaped such that its length in the circumferential direction is greater than its length in the direction in which the communicating path and the bearing seal portion are linked by the shortest distance.

7. The hydrodynamic bearing device according to claim 1,
wherein the flow suppressor is wider than the spacing of two external tangents that link the communicating path and the bearing seal portion.

8. The hydrodynamic bearing device according to claim 1,
further comprising an enlarged space portion disposed on the opposite side of the flow suppressor to the communicating path in the radial direction of a circle whose center is the rotational axis of the shaft member, in which the gap is larger than in other portions.

9. The hydrodynamic bearing device according to claim 1,
wherein the flow suppressor is a circular convex portion disposed between the communicating path and the bearing seal portion via a flow gap narrower than a gap near the communicating path.

10. A spindle motor in which the hydrodynamic bearing device according to claim 1 is mounted.

11. An information device in which the spindle motor according to claim 10 is mounted.
